(19) United States
(12) Patent Application Publication
(10) Pub. No.: US 2009/0242527 A1
(43) Pub. Date: Oct. 1, 2009

(54) Method and Apparatus for Processing Coated Spectacle Lenses

(76) Inventor: Wilhelm Anger, Salzburg (AT)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/410,234

(22) Filed: Mar. 24, 2009

(30) Foreign Application Priority Data
Mar. 25, 2008 (EP) 08153223.6

(51) Int. Cl. B23K 26/08; B23K 26/38; G01B 11/24

(52) U.S. Cl. 219/121.69; 219/121.68; 219/121.78; 356/612

(57) ABSTRACT

By means of the method and the apparatus in accordance with the invention, coated spectacle lenses are processed to form at the latter joining surfaces which permit a reliable adhesive bonding of the lenses to the bridge and the lugs of rimless spectacles. The method provides that for the respective spectacle lens two processing areas are predetermined with the shape, size and location thereof at the lens and that in the two predetermined processing areas the coating at the lens is locally removed by irradiation by a laser beam. The apparatus excels by a holder including at least one mount for a lens, a laser beam device including a laser head for generating a laser beam, a positioning device for moving the holder and the laser head relative to each other in a reference plane and a control means wherein for the laser beam device and the positioning device, wherein the laser power, the relative position between the laser head and the at least one lens as well as a scanning motion of the laser beam are controllable by the control means wherein.

### CROSS-REFERENCE TO RELATED APPLICATIONS

This application claims priority to European Patent Application No. 0815323.6, filed on Mar. 25, 2008, the contents of which are incorporated herein by reference in their entirety.

### FIELD OF THE INVENTION

The invention relates to a method and an apparatus for processing coated spectacle lenses.

### BACKGROUND OF THE INVENTION

Rimless spectacles are known which comprise two spectacle lenses, a bridge, two lugs and two sides each of which is hingedly connected to either of the two lugs. The bridge is formed integrally with a saddle bridge or two pads, or it supports two pads or a saddle bridge. Such rimless spectacles have no mount members extending along the upper edges and/or the lower edges of the spectacle lenses and connecting the bridge to the lugs. The coherence between the lugs and the bridge is rather ensured by the spectacle lenses disposed therebetween. Therefore it is necessary to mechanically connect the lugs and the bridge to the spectacle lenses in a sufficiently tight manner.

It is known already to establish the connection between the lugs and the bridge, on the one hand, and the respective spectacle lens, on the other hand, by initially forming at least one through-hole in the lens at the mounting position for the lugs and/or the bridge. A screw or a rivet can be inserted in the through-hole so as to screw or to rivet the lug or the bridge with the lens. It is also known to provide at the component to be fixed, i.e. at the lug or the bridge, a pin which is glued or keyed in the through-hole of the spectacle lens. These known ways of connection have the drawback that through-holes have to be formed in the lenses. When forming the through-holes by drilling, for instance, there is the risk that the spectacle lens breaks, which results in considerable rejects during manufacture of such rimless spectacles. Furthermore, the through-holes cause a structural weakening and micro-fissures in the spectacle lenses and the pressure exerted by screws or rivets entails tensions in the lenses which results in an increased risk of breakage during use of the spectacles.

It has already been suggested in the case of rimless spectacles to adhesively bond the bridge and/or the lugs to the spectacle lenses on the front or rear side thereof. By the bonding of the bridge and the lug to the lenses through-holes shall and can be prevented from having to be formed in the lenses so that the drawbacks related with the formation of through-holes in the spectacle lenses, for instance by drilling, are avoided.

Previous efforts to manufacture rimless spectacles by adhesively bonding the lugs and the bridge to the front side or the rear side of the lenses have not been successful, because no permanently tight adhesively bonded joints could be obtained and the adhesively bonded joints frequently broke.

### SUMMARY OF THE INVENTION

Spectacle lenses usually have on their front side and their rear side a coating which is to ensure scratch resistance and/or dirt-repelling properties and/or particular reflection characteristics of the lens surfaces. The inventors found that this coating is one of the essential causes for poor adhesively bonded joints. The inventors further found that permanently tight adhesively bonded joints can be obtained when the coating is removed in the area of the joining surfaces for the adhesively bonded joint prior to adhesive bonding.

Accordingly, one object underlying the invention is to provide an appropriate method which permits to remove the coating in limited areas at coated spectacle lenses so as to provide joining surfaces for adhesively bonding the lenses to fasteners of the bridge and the lugs. It shall be possible to precisely remove the coating in previously defined areas and it shall further be possible to remove the coating up to its entire thickness without a considerable amount of base material of the lens being removed. Furthermore, another object underlying the invention is to provide an apparatus suited for implementing said method.

The first mentioned object is achieved according to the invention by the method defined in claim 1. In accordance with the invention, it is provided that for the respective spectacle lens two processing areas are predetermined with the shape, size and location thereof at the lens and that in the two predetermined processing areas the coating on the lens is locally removed by irradiation by a laser beam.

The object mentioned second is achieved according to the invention by the apparatus defined in claim 10. This apparatus comprises a holder including at least one mount for a spectacle lens, a laser beam device including a laser head for generating a laser beam, the laser power of the laser beam being controllable such that it is sufficient for processing the at least one lens by local removal of the coating thereof so that the laser head is suited for processing the at least one spectacle lens, a positioning device for moving the holder and the laser head relative with respect to each other in a reference plane, and a control means for the laser beam device and the positioning device, wherein the laser power, the relative position between the laser head and the at least one lens as well as a scanning motion of the laser beam are controllable by the control means.

Advantageous further developments of the invention are defined in the dependent claims.

### BRIEF DESCRIPTION OF THE DRAWINGS

The features of the invention and the advantageous effects thereof will be illustrated in detail hereinafter by way of embodiments and with reference to the drawings.

FIG. 1 is a perspective view of rimless spectacles during manufacture of which the method according to the invention and the apparatus according to the invention are applicable;

FIG. 2 is a front view of the left-hand lens of the spectacles according to FIG. 1;

FIG. 3 shows, in a representation similar to FIG. 2, a spectacle lens which differs from the lens shown in FIG. 2 by its lens shape;

FIG. 4 shows a processing area at a spectacle lens in a cut-out and enlarged representation;

FIG. 5 is a schematic sectional view according to A-B in FIG. 4;

FIG. 6 is a side view of a spectacle lens in connection with a lens clamp;

FIG. 7 is a perspective and schematic view of an apparatus in accordance with a first embodiment of the invention;

FIGS. 8A, 8B and 9 are schematic views of a spectacle lens, a laser head and a laser beam emitted by the laser head for illustrating a scanning motion performed by the laser beam;

FIG. 10 is a block diagram of elements of the apparatus according to the first embodiment;

FIG. 11 shows a reference coordinate system of the apparatus according to the first embodiment as well as spectacle lenses disposed in the apparatus;

FIG. 12 shows a cut-out in a representation similar to FIG. 5 of a spectacle lens during processing;

FIG. 13 is a diagram showing the control of laser power in dependence on the incident angle of a laser beam;

FIG. 14 is a perspective and schematic view of an apparatus according to a second embodiment of the invention;

FIG. 15 shows a block diagram of elements of the apparatus according to the second embodiment;

FIG. 16 shows a block diagram including method steps of the method according to a second embodiment of the invention;

FIG. 17 is a top view of a spectacle lens while the contour thereof is measured;

FIG. 18 shows the spectacle lens according to FIG. 17 when viewed in the direction of an arrow C in FIG. 17;

FIG. 19 shows a side view of a spectacle lens, while the curvature thereof is measured;

FIG. 20 is a top view of a spectacle lens, while processing areas at the same are processed; and

FIG. 21 is a view of the spectacle lens when viewed in the direction of an arrow E in FIG. 20.

### DETAILED DESCRIPTION OF THE DRAWINGS

Hereinafter, first of all by way of the FIGS. 1 to 3, an embodiment of rimless spectacles will be illustrated during manufacture of which the method according to the invention and the apparatus according to the invention are applicable.

FIG. 1 shows rimless spectacles in a perspective view obliquely from the front. The spectacles comprise a left-hand spectacle lens 2, a right-hand spectacle lens 4 and a bridge 6 disposed between the two lenses. Each of the two lenses 2 and 4 has a front side 3 visible in FIG. 1 and a circumferential edge 5 radially outwardly confining the lens with respect to its geometrical and optical centers. The bridge 6 is an elongated member disposed between the two lenses 2 and 4 and interconnecting the latter. The bridge comprises a body 8 and two fasteners 18 each of which is disposed at one end of the bridge 6 and bonded to the front side 3 of the lens 2 and 4, respectively. A pad member 10 is mounted to the bridge 6 and serves for supporting the spectacles at the nose of the wearer.

The spectacles further comprise a left-hand lug 12 and a right-hand lug 14. The lugs 12 and 14 are hingedly connected to a respective side 15 in such manner that the sides 15 can be swiveled from their open positions shown in FIG. 1 into positions in which they extend substantially in parallel to the two lenses 2 and 4.

Each of the two lugs 12 and 14 comprises a body 16 and a fastener 18 disposed at the end of the lug 12 or 14 facing away from the side 15. The fasteners 18 of the two lugs 12 and 14 are bonded to the front side 3 of the lens in a respective edge portion of the lens 2 or 4 facing away from the bridge 6.

The fasteners 18 of the bridge 6 and the lugs 12 and 14 usually consist of injection-moldable plastic material, for instance aliphatic thermoplastic polyether polyurethane, as it is marketed, for instance, by Bayer AG Bayer Polymers under the designation Texin DP7-3007. The body 8 of the bridge 6 and the bodies 16 of the lugs 12 and 14 consist of a metallic material or of an injection-moldable plastic material and are tightly connected to the respective fastener 18. For this purpose, a free end portion, not represented, of the respective body 8 and 16, respectively, is inserted in the allocated fastener 18 and is fixedly anchored there by form fit and/or force fit and/or adhesive bonding. As an alternative, the tight connection between the fastener and the respective body can also be established by attaching the fastener by injection-molding to the free end portion of the body. In deviation from the described embodiment, the respective body and the fastener or fasteners can be integrally manufactured of the same material.

The usual materials of spectacle lenses are taken into consideration as base material for the lenses. They include especially plastics, such as polycarbonates and allyl diglycol carbonate known as spectacle lens material under the designation CR39.

Each of the two spectacle lenses 2 and 4 is a coated lens. This means that it has a coating on its front side and its rear side, wherein the coatings on the front side and on the rear side can be different. The respective coating is usually made of plural layers. One layer of the coating can be, for instance, a so-called hard layer which is to ensure scratch resistance of the surface of the lens. On the hard layer, an antireflection layer can be provided which, in turn, can consist of plural layers. The antireflection layer is to suppress regular reflection. As an alternative, a reflective layer can be applied, if a high reflectivity is desired. The uppermost layer of the coating is a dirt-repelling layer, for instance, which has hydrophobic and oleophobic characteristics and is to prevent dirt from adhering. The total thickness of a coating usually is within the range of less than 1 μm to few micrometers.

The coated lenses 2 and 4 have a lens shape, as it is called. The lens shape usually is the geometrical shape of the contour of the lens when viewing the same from its front side or its rear side. FIG. 2 shows a view of the left-hand lens 2 of the spectacles according to FIG. 1 when viewed from the front side 3 thereof. The lens 2 is radially outwardly confined by its contour 20 which in FIG. 2 coincides with the edge 5 of the lens.

A lens is commonly manufactured, starting out from a lens blank having a circular contour, by removing from the lens blank by cutting and/or grinding so much material that the lens having the desired contour 20 and the desired lens shape is obtained.

Each of the spectacle lenses 2 and 4 has a datum line 22 and a lens vertical 24 (cf. FIG. 2). The datum line 22 passes through the geometrical center M of the lens and connects the geometrical centers of the two lenses of the finished spectacles. The lens vertical 24 vertically intersects the datum line 22 in the geometrical center M of the lens. The datum line 22 and the lens vertical 24 are auxiliary lines that can be marked (but need not be marked) at the lenses, the respective markers being removed when they are no longer required and being no longer visible at the finished spectacles. The datum line 22 and the lens vertical 24 define a lens coordinate system in which the place of each point on the surface and at the edge of the lens is defined by its coordinates. Instead of the geometrical center, a different point defined at the lens can serve as origin of the lens coordinate system.

As explained already, the fasteners 18 are disposed on the front side 3 of the respective lens 2 and/or 4, for which purpose they are adhesively bonded to the front side 3 in the course of the manufacture of the rimless spectacles. As an alternative, the fasteners 18 can also be adhesively bonded to the rear side of the respective spectacle lens. Hereinafter, it shall be assumed that the fasteners 18 are adhesively bonded to the front side 3 of the spectacle lens 2 and/or 4, wherein the following explanations apply mutatis mutandis also to the case that the fasteners 18 are adhesively bonded to the rear sides of the lenses. Furthermore, the adhesive bonding of the fasteners 18 to the front side or the rear side does not exclude that the respective fastener 18 is additionally bonded to the edge 5 of the spectacle lens.

Each fastener to be adhesively bonded to the spectacle lens has a joining surface. The lens includes for each of the fasteners to be bonded a joining surface which in shape and size is complementary to the joining surface of the fastener. In the course of manufacture of the rimless spectacles the respective fastener is attached with its joining surface to the lens and is adhesively bonded to the lens by means of an adhesive introduced between the joining surfaces or an adhesive film on both sides provided with an adhesive layer and disposed between the joining surfaces.

The joining surfaces at the lens are formed by removing the coating in the area of a joining surface to be formed in its entire thickness so that the base material of the lens is exposed in the area of the joining surface. This is done to achieve a permanently tight adhesive bond between the fasteners and the lenses. The coating provided at the spectacle lens is correspondingly removed in an area which, as to its location at the lens and its shape and size, coincides with the shape and the size as well as the location of the joining surface to be formed at the lens. Hereinafter this area will be referred to as processing area.

In FIG. 2 a processing area 26 and a processing area 28 are shown as hatched fields. In the processing area 26 the joining surface is formed to which the fastener for the left-hand lug of the spectacles is attached, and in the processing area 28 the joining surface is formed to which either of the fasteners of the bridge is attached.

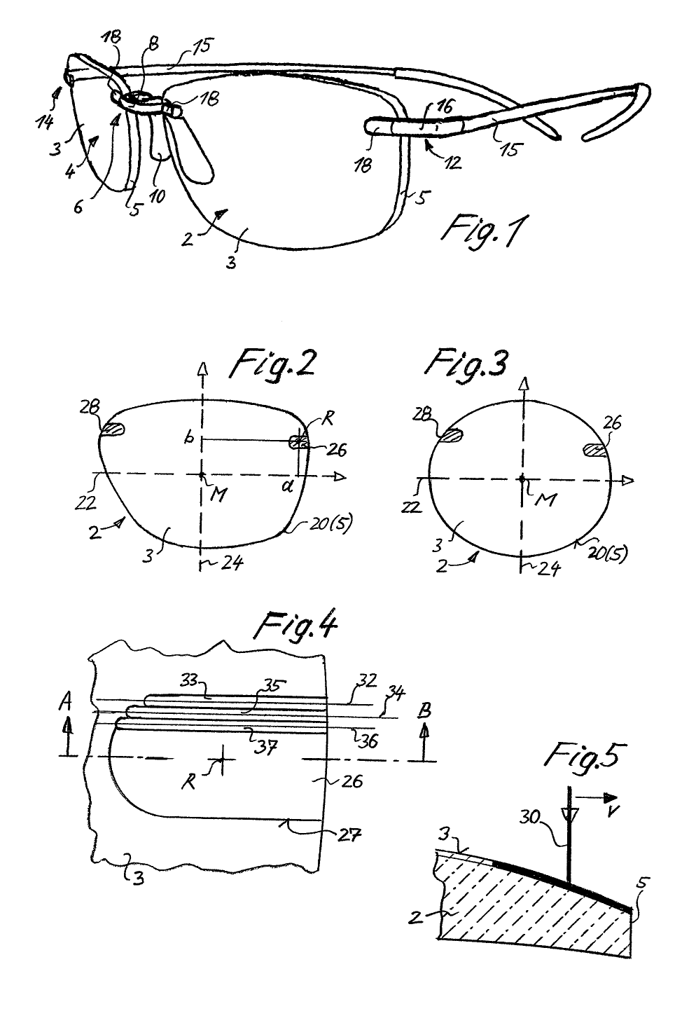

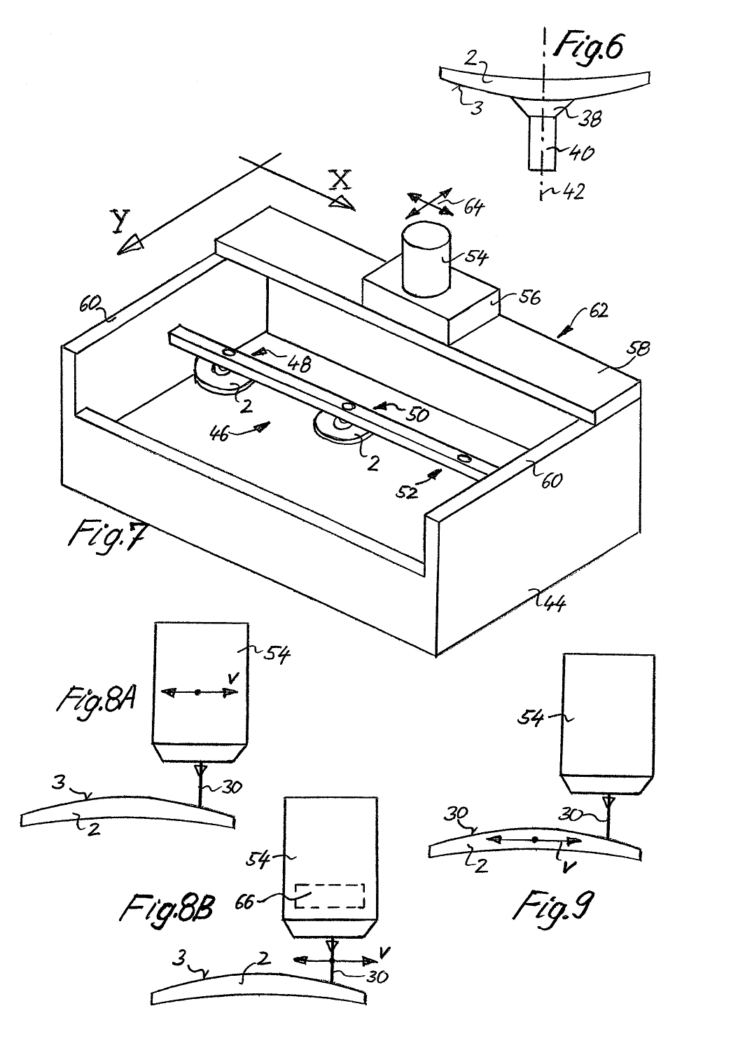

The lens shape of the spectacle lens and thus the contour 20 thereof are predetermined by the spectacle design chosen by the wearer or by the spectacle manufacturer. The locations of the processing areas 26 and 28 at the lens are also predetermined by the chosen spectacle design. The spectacle manufacturer predetermines the shape and the size of the processing areas 26 and 28 depending on the shape and the size of the joining surface at the fastener. The location of the processing areas at the lens can be predetermined, for instance, in the lens coordinate system by the coordinates a and b of a reference point R in the processing area, as this is shown for the processing area 26 in FIG. 2. In this event, the shape and the size of the processing area are predetermined by the distances (in the direction of the datum line 22 and in the direction of the lens vertical 24) of points of the contour 27 of the processing area (cf. FIG. 4) from the reference point R. Alternatively, the shape, the size and the location of the processing area can be predetermined by defining the contour 27 of the processing area in the lens coordinate system.

In the lens 2 illustrated in FIG. 2 each of the processing areas 26 and 28 extends to the edge 5 of the lens. Deviating from that, the processing areas 26 and 28 can be disposed at the lens at a particular distance from the edge 5.

Numerous different lens shapes of spectacle lenses are known and new lens shapes will be developed in the future. The present invention is applicable to spectacle lenses having any lens shape, wherein, however, the lens has its predetermined lens shape at the time at which it is processed according to the method of the invention and by means of the apparatus according to the invention. FIG. 3 shows, in a representation similar to FIG. 2, a lens having a lens shape different from that of the lens according to FIG. 2, the lens shape shown in FIG. 3 being merely an example of one of the numerous possible presettable lens shapes.

In accordance with the invention, the coating at the lens is locally removed in the processing area by irradiation by a laser beam. This is schematically illustrated in the FIGS. 4 and 5, FIG. 4 showing in a cut-out and enlarged view the processing area 26 of the lens 2 when viewed from the front side 3 thereof. A laser beam 30 generated by a laser beam device described in detail further below is directed onto the lens 2 so that it is incident on the lens at least in the processing area 26. The laser beam 30 and the lens 2 are displaced and/or moved relative to each other at a scanning velocity v in such manner that the point of incidence of the laser beam 30 at the lens 2 sweeps over a straight line 32, for instance. For this purpose, in FIG. 5 the laser beam 30 is displaced preferably in parallel to itself, while the lens 2 remains stationary. In the same way, further lines 34 and 36 are swept over by the point of incidence of the laser beam 30 so that finally the entire processing area 26 has been swept over by the laser beam 30. The relative movement between the laser beam 30 and the lens 2 required for sweeping over a line and for the transition from one line to another will hereinafter be referred to as scanning motion.

The laser beam 30 has a small cross-sectional area and is preferably a so-called parallel beam, i.e. a beam consisting of light rays parallel to each other. The laser power, i.e. the power of the laser beam 30, is set such that the power density, i.e. the amount of energy irradiated at the point of incidence per unit time and unit surface area, is sufficient taking the scanning velocity v into account to destroy the coating up to its entire thickness and thus to remove strips 33, 35 and 37 and further strips of the coating. The laser beam 30 exhibits this power only while it sweeps over the processing area 26 so that the removal of the coating is restricted to the processing area 26.

Hereinafter a first embodiment of the method according to the invention and the apparatus according to the invention is illustrated with reference to FIGS. 6 to 13.

Each spectacle lens to be processed in the manner explained in the foregoing by way of FIGS. 4 and 5 is detachably mounted to a lens clamp 38 for the purpose of processing (cf. FIG. 6). This may be the lens clamp to which the lens has been detachably mounted to handle it while the lens shape of the lens is formed. The lens clamp 38 includes a pin 40 and is usually mounted to the lens 2 such that the axis 42 of the pin 40 extends through the geometrical center M of the lens, namely through the intersection of the datum line 22 and the lens vertical 24. In FIG. 6 the spectacle lens 2 is mounted to the lens clamp 38 with its front side 3.

The apparatus according to the first embodiment of the invention represented schematically and in perspective in FIG. 7 comprises a housing 44 in which a holder 46 for spectacle lenses is arranged. The holder 46 serves for holding one or more lenses so that during processing the laser beam can be directed onto the respective lens in the required way and sweep over the same. The holder 46 includes at least one mount for a spectacle lens. In the shown embodiment the holder 46 is a rod including a first mount 48, a second mount 50 and a third mount 52 each of which is formed by a section of the rod and a pin hole formed in the section into which the pin 40 of the lens clamp 38 can be inserted.

A two-dimensional reference coordinate system having in the shown embodiment the coordinate axes X and Y shown in FIG. 7 and perpendicular to each other is assigned to the apparatus. These coordinate axes X and Y define a reference plane. The mounts 48, 50 and 52 hold the respective lens disposed at the same such that the optical axis thereof (not shown) substantially extends perpendicular to the reference plane.

The apparatus according to the first embodiment further comprises a laser beam device. The laser beam device is referred to in this description and the claims as a device which generates and emits a laser beam in a controlled manner by which a surface can be swept over in order to measure and/or process the same. The laser beam device comprises a laser head 54 in which a (not represented) laser including a laser light source and a laser optical system is disposed. The laser generates in a controlled manner laser light which is formed into the laser beam 30 by the laser optical system. The laser head 54 emits the laser beam 30 preferably in a direction perpendicular to the reference plane. Furthermore, the laser beam device includes driver and control electronics integrated in a control means explained further below.

The laser head 54 is arranged at a first carriage 56 and is supported by the same. The first carriage 56 is arranged at a second carriage 58 supporting and guiding the first carriage 56. The first carriage 56 is movable at the second carriage 58 in a first direction which is the direction of the coordinate axis X in the shown embodiment. The second carriage 58 is supported and guided by rails 60 which are fastened at the housing 44 and extend in the direction of the coordinate axis Y. For displacing the first carriage 56 relative to the second carriage 58 and for displacing the second carriage 58 on the rails 60 relative to the housing 44 actuating drives which are not shown are provided. The two carriages 56 and 58, the rails 60 and the actuating drives that are not shown are elements of a positioning device 62 by means of which the laser head 54 of the laser beam device, on the one hand, and the holder 46 including its mounts 48, 50 and 52, on the other hand, can be moved in any desired position relative to each other in the reference plane. In the shown embodiment this is performed by moving or displacing the laser head 54 in the reference plane defined by the coordinate axes X and Y relative to the holder 46 which is stationary in the apparatus.

The positioning device 62 can further include a not represented fine adjustment means arranged at the first carriage 56 by which the laser head 54 can be moved or displaced relative to the first carriage 56 in the direction of the coordinate axes X and Y, as indicated by intersecting double arrows 64 in FIG. 7.

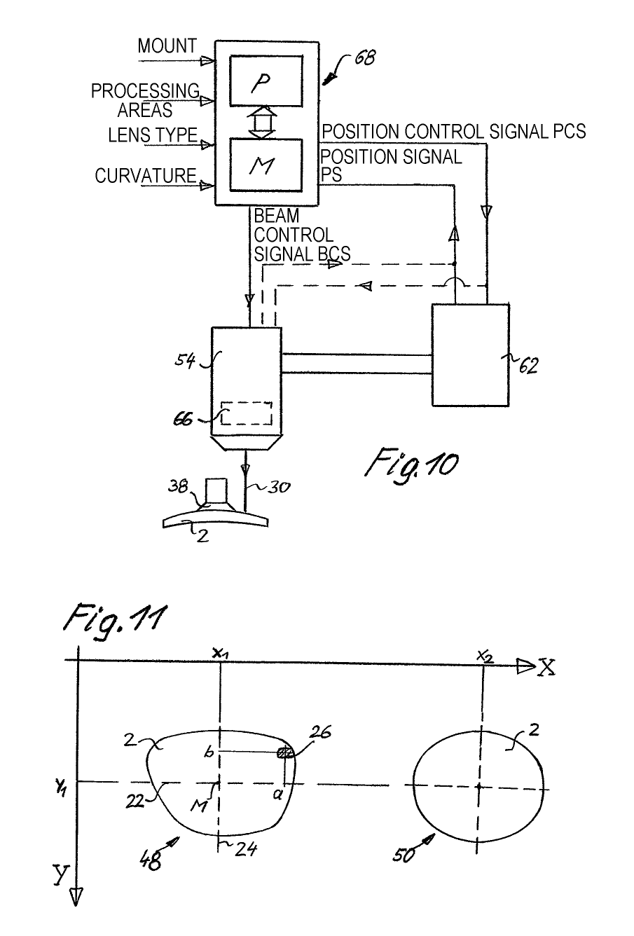

The positioning device 62 serves for moving the laser head 54 into any desired position above spectacle lenses arranged at the mounts 48, 50 and 52. The scanning motion required for processing the lenses in the manner basically explained above by way of FIGS. 4 and 5, i.e. the relative movement between the laser beam 30 and the lens 2, can be carried out by moving the laser head 54 on the whole by means of the positioning device 62 above a processing area so that the laser head 54 itself executes the scanning motion at the scanning velocity v. This is schematically shown in FIG. 8A. As an alternative, the scanning motion of the laser beam 30 can be caused by a beam deflection means 66 integrated in the laser head 54 (cf. FIG. 8B). In this case, the laser head is stationary above the processing area and the beam deflection means 66 displaces the laser beam 30 in parallel to itself at the scanning velocity v. This is schematically shown in FIG. 8B.

In the above-described embodiment illustrated in FIG. 7 the laser head 54 is arranged at the positioning device 62 and the latter serves for moving the laser head 54 into any desired position with respect to the lenses disposed at the holder 46. In modification of this embodiment it may be provided that the holder 46 is arranged at the positioning device 62, while the laser head 54 of the laser beam device is fixedly mounted at or in the housing 44 so that the positioning device serves for moving the holder and the lenses disposed at the latter into any desired position with respect to the laser head 54. In this modified embodiment the scanning motion can be carried out by moving each lens 2 at the scanning velocity v, while the laser head executes no movement, as schematically shown in FIG. 9. The second embodiment described further below of the method according to the invention and the apparatus according to the invention can be modified in the same way. Hereinafter these modifications will not be further discussed, the following explanations being applicable mutatis mutandis to the modified embodiments, too.

The apparatus according to the first embodiment furthermore comprises a control means 68 shown in FIG. 10. By the control means 68 the positioning device 62 and the laser beam device are controlled. Especially the position of the laser head 54 in the reference coordinate system of the apparatus, the power of the laser beam 30 emitted by the laser head 54 and the scanning motion of the laser beam 30 are controlled by the control means 68.

The control means 68 and the interaction thereof with the laser head 54 and the positioning device 62 are illustrated schematically in FIG. 10. The control means 68 comprises a processor P as well as a memory M in which algorithms and data required by the processor P are stored. A position signal PS on the basis of which the control means 68 calculates the actual position of the laser beam 30 in the reference coordinate system is transmitted to the control means 68. In the reference coordinate system the position of the laser beam 30 is simultaneously the position of the point of incidence of the laser beam 30 on a lens arranged at one of the mounts, when the laser beam is emitted perpendicular to the reference plane, as this is preferably provided. The control means 68 receives the position signal PS from the positioning device 62 or receives it from the positioning device 62 and the laser head 54, when the scanning motion of the laser beam 30 is caused by the beam deflection means 66 integrated in the laser head 54.

The control means 68 transmits to the positioning device 62 and, where appropriate, to the laser head 54 a position control signals PCS on the basis of which the positioning device 62 and possibly the beam deflection means 66 arrange the laser beam 30 at the position in the reference coordinate system defined by the position control signal PCS. As the position control signal PCS is variable in time, also the scanning motion of the laser beam 30 in the processing area is controlled by the position control signal PCS. Furthermore, the control means 68 transmits a beam control signals BCS corresponding to which the laser head 54 adjusts the power of the laser beam 30 to the laser head 54.

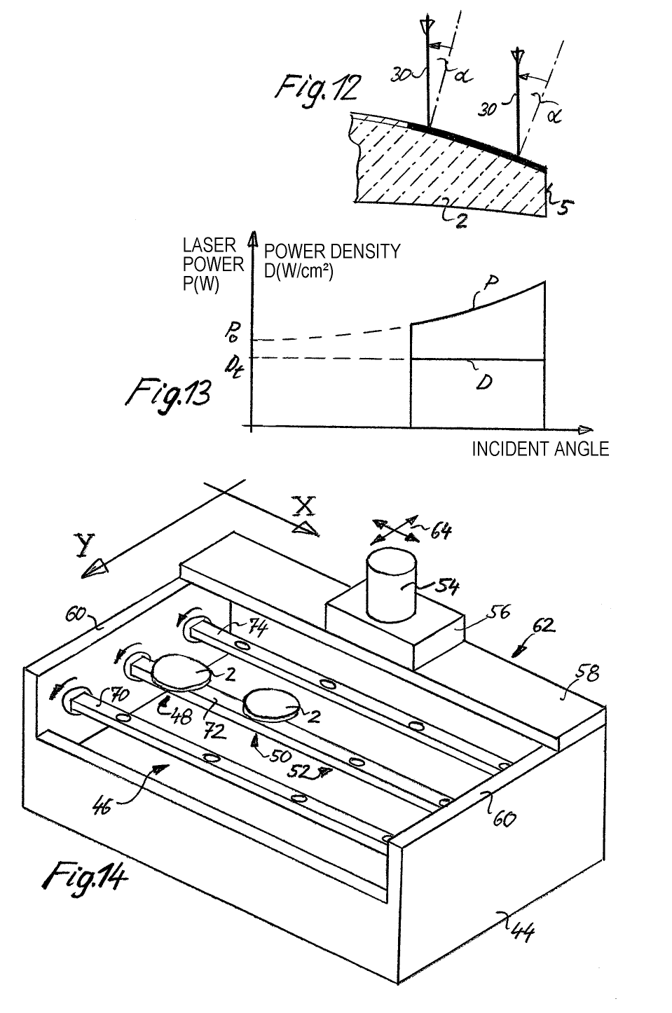

For processing a spectacle lens by the above-described apparatus, the lens is disposed at one of the mounts 48, 50 and 52 of the apparatus in such a way that its front side faces the laser head 54 when the laser head is positioned above the mount. The lens having the lens shape shown in FIG. 2 is arranged, for instance, at the first mount 48 by inserting the pin 40 of the lens clamp 38 into the pin hole of the first mount 48, the datum line 22 and the lens vertical 24 of the spectacle lens being aligned in parallel to the coordinate axis X and the coordinate axis Y, respectively (cf. FIG. 11). When the axis 42 of the pin 40 of the lens clamp 38 extends through the geometrical center M of the lens and thus through the origin of the lens coordinate system, the geometrical center M of the lens is located in the reference coordinate system of the apparatus on the axis of the pin hole of the first mount 48. The position of the axis of the pin hole in the reference coordinate system is known and defined by the coordinates x₁ and y₁ (cf. FIG. 11). In the same way, further lenses can be arranged at the mounts 50 and 52. For example, at the second mount 50 a lens having the lens shape according to FIG. 3 is arranged.

In the afore-described manner the respective spectacle lens is allocated to one of the mounts. The lens has its predetermined lens shape. Further, the two processing areas are predetermined in the lens coordinate system for said lens according to shape, size and location at the lens. For each of the lenses data identifying the allocated mount and data identifying at least the locations of the two processing areas in the lens coordinate system are entered into the control means 68. In FIG. 10 these are the inputs “mount” and “processing areas”. Based on said inputs, the control means 68 calculates for each lens the locations of the processing areas in the reference coordinate system. The coordinates of the location of the processing area 26 at the lens disposed at the first mount 52 are calculated, for instance, by (x₁+a) and (y₁−b), the parameters x₁, y₁, a and b having the meaning already explained in the foregoing.

Moreover, the control means 68 calculates for each processing area the contour 27 thereof (cf. FIG. 4) in the reference coordinate system. This calculation is made by way of data stored in the memory M concerning shape and size of the processing areas or based on data entered into the control means 68 with the input “processing areas” for the respective mount or the respective spectacle lens.

On the basis of said calculations, the control means 68 defines the position control signal PCS such that the laser head 54 is positioned by means of the positioning device 62 in the reference coordinate system above the respective processing area and that the laser beam executes the scanning motion illustrated already in the foregoing by way of the FIGS. 4, 5, 8A and 8B in the entire processing area.

In the simplest case, the control means 68 controls via the beam control signal BCS the laser power in such a way that the power density at the point of incidence of the laser beam 30 in the processing area is sufficient for removing the coating for all incident angles at the point of incidence and lens types in question. The laser power required for this purpose is established by preliminary tests taking the scanning velocity v into account. In this case the base material of the lens and the structure of the coating, i.e. the material composition, the thickness and the sequence of the layers of the coating, are referred to as lens type.

Preferably, however, the laser power is controlled depending on the respective lens type. To this end, it is established by preliminary tests for each lens type in question which laser power is required to remove the respective coating at all incident angles in question up to its entire thickness in the processing area. In this way, the lens type is allocated to the required laser power. The data pairs of lens type and laser power are stored in a data table in the memory M of the control means 68. In this event, in the control means 68 data identifying the lens type are entered for each mount in addition to the data identifying the processing areas (input “lens type” in FIG. 10). Via the beam control signal BCS the control means 68 then controls the laser power in the processing area at a respective mount depending on the entered lens type and the desired value of the laser power stored for this lens type in said data table. In this manner it is achieved that the laser power is adapted to the respective lens type of the spectacle lens, especially to the structure of the coating, so that the coating is removed in the processing area in its entire thickness and the base material of the lens is not or only insignificantly removed.

In order to avoid variations of the power density in the processing area, the laser power is preferably controlled in dependence on the incident angle of the laser beam in the processing area, as will be explained hereinafter. This control can be performed in addition to the above-explained control of the laser power depending on the lens type or as an alternative thereto.

Usually each spectacle lens has a curved front side and a curved rear side. A measure for curvature is, for instance, the radius of curvature of the front and/or rear side in total or the local radius of curvature in the event of a non-spherical lens surface. The incident angle α varies depending on the position of the point of incidence at the lens in the reference coordinate system, (cf. FIG. 12). With a constant laser power during processing the power density is maximal at the point of incidence, when the incident angle α equals zero, and the power density decreases, when the incident angle α increases. Accordingly, when the laser power remains constant, the power density varies during the scanning motion in dependence on the position of the point of incidence of the laser beam in the reference coordinate system. In order to nevertheless keep the power density in the processing area substantially constant, the power of the laser beam is controlled in response to the incident angle at the point of incidence. For this purpose, data identifying the curvature of the spectacle lens are entered into the control means 68 for each mount (input “curvature” in FIG. 10). On the basis of the inputs allocated to a mount concerning the processing areas and concerning the curvature, the control means calculates in the reference coordinate system for each position of the point of incidence of the laser beam 30 in the processing area the incident angle α and therefrom, in turn, the power of the laser beam required to obtain a constant power density in the processing area. This power is substantially proportional to (1/cos α). Based on this calculation of the laser power, the control means 68 determines the beam control signal BCS transmitted to the scanning head 54.

It is achieved in the above-described manner that, despite the curvature of the surface of the lens and the variation of the incident angle of the laser beam caused thereby during the scanning motion in the processing area, the power density remains substantially constant in the entire processing area and, accordingly, the coating is removed in the entire processing area up to the same depth. This is schematically shown in the diagram according to FIG. 13 in which the calculated laser power P and the power density D are represented at the point of incidence depending on the incident angle α. The power density D constantly has the value Dₜ which is required for removing the coating in its entire thickness, while the laser power increases from the value P₀ proportional to (1/cos α). P₀ is the laser power assigned to Dₜ in the case of an incident angle α=0.

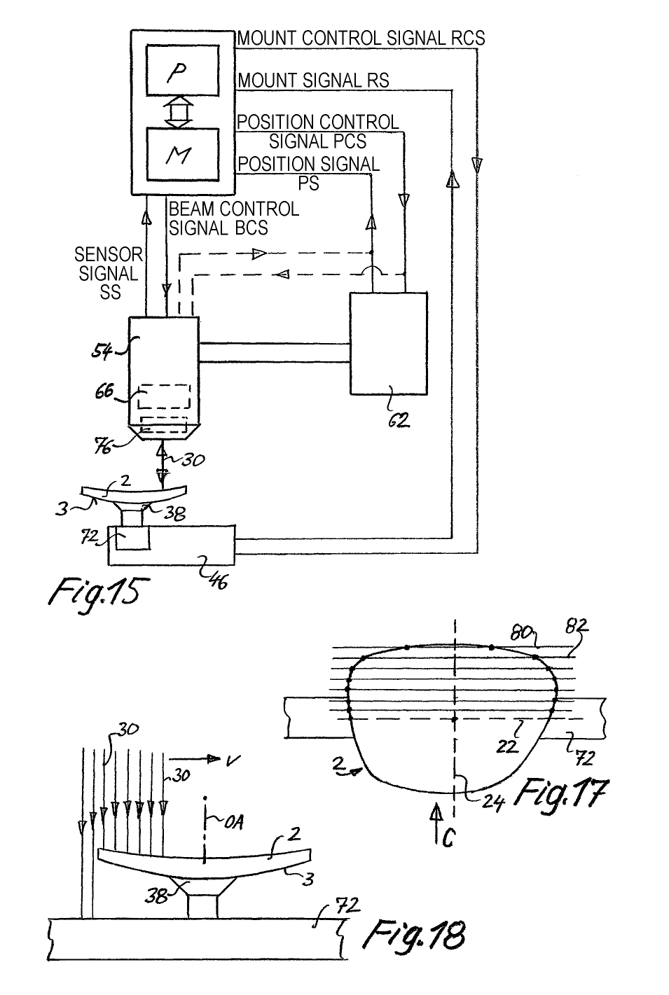

Hereinafter a second embodiment of the method according to the invention and the apparatus according to the invention will be illustrated with reference to the FIGS. 14 to 21. Elements of the second embodiment of the apparatus according to the invention which are equal to or correspond to elements of the first embodiment are denoted with the same reference numerals as in the first embodiment. The explanations of said elements in connection with the first embodiment apply mutatis mutandis to the second embodiment, too, unless anything to the contrary will be stated in the following.

The apparatus according to the second embodiment shown schematically and in perspective in FIG. 14 differs from the apparatus according to the first embodiment by the design of its holder 46 and its laser head 54 as well as by additional functions of the control means 68. FIG. 15 schematically shows, in a representation similar to FIG. 10, for the second embodiment the control means 68 thereof and the interaction thereof with the laser head 54, the positioning device 62 and the holder 46.

The holder 46 of the apparatus according to the second embodiment comprises plural rods 70, 72 and 74 extending in parallel to each other which are pivoted about their longitudinal axis in the housing 44. Each of the rods 70, 72 and 74 includes plural juxtaposed mounts for a spectacle lens of which merely the mounts 48, 50 and 52 at the rod 72 are identified by their reference numerals in FIG. 14. In this embodiment, each of the mounts is formed by a section of one of the rods 70, 72 and 74 and a pin hole formed in the section into which the pin 40 of a lens clamp 38 can be inserted. As in the case of the first embodiment, for instance the spectacle lens having the lens shape shown in FIG. 2 is disposed at the mount 48 and the lens having the lens shape shown in FIG. 3 is disposed at the mount 50.

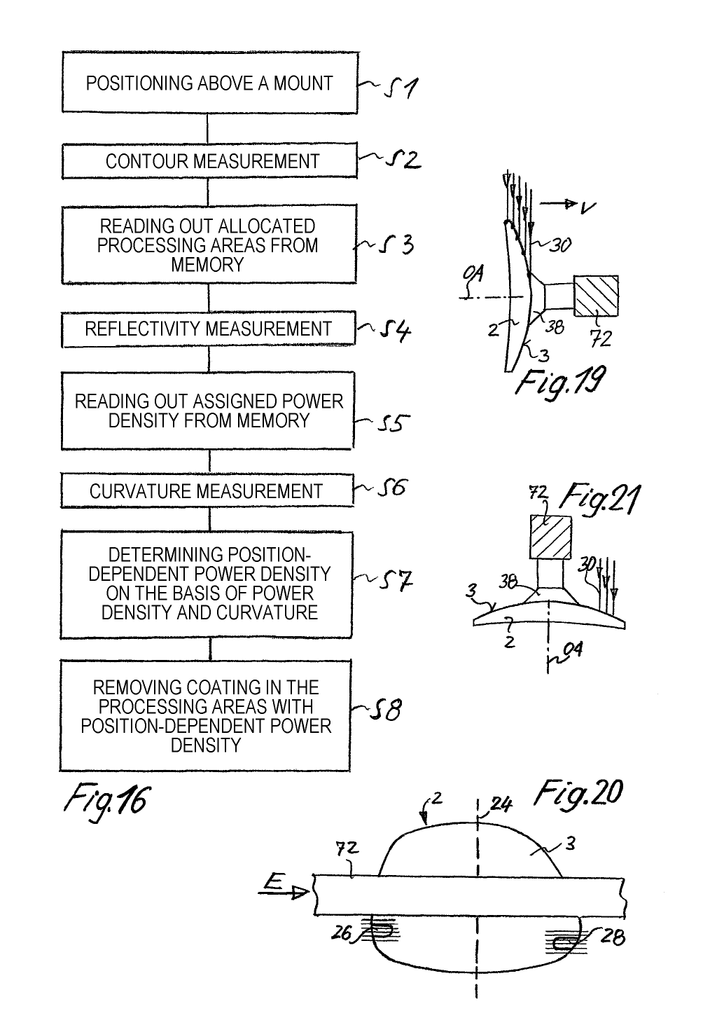

Further spectacle lenses can be disposed at all other mounts. When the rods 70, 72 and 74 adopt their position represented in FIG. 14, the mounts thereof hold the respective lens disposed at the same such that the optical axis OA of the lens (cf. FIGS. 18 and 19) extends substantially perpendicular to the reference plane. By rotating or swiveling the rods 70, 72 and 74 and the mounts thereof out of the position shown in FIG. 14 they can align the optical axis OA of the respective lens in a presettable direction with respect to the reference plane. The rods 70, 72 and 74 and thus the mounts thereof are rotated or swiveled with the aid of actuating drives which are not shown. For this purpose, the control means 68 transmits a mount control signal RCS to the holder 46 which predetermines the desired position of the mounts. The holder 46 transmits a mount signal RS corresponding to the actual position of the mounts to the control means 68 (cf. FIG. 15).

The laser head 54 of the apparatus according to the second embodiment differs from the laser head 54 of the apparatus according to the first embodiment by the fact that, in addition to the laser which is capable of generating and emitting the laser beam 30 and the beam deflection means 66 integrated in the laser head 54 if necessary, it includes a sensor 76 that is capable of detecting reflected laser light (cf. FIG. 15). Due to the reflected laser light detected by means of the sensor 76, the laser head 54 transmits a sensor signal SS to the control means 68.

The control means 68 detects from the sensor signal SS the distance between the laser head 54 and the point of incidence of the laser beam 30 at an object, for instance at the spectacle lens 2, in accordance with methods known per se, for example pulse testing or phase testing, so that the geometry of the lens 2 can be detected and/or measured by sweeping over the lens 2 in lines or at points of a raster by means of the laser beam 30.

Furthermore, the control means 68 establishes from the sensor signal SS the intensity of the reflected laser beam and establishes the reflectivity at the respective point of incidence on the basis of the ratio of the intensity of the reflected laser beam and the intensity of the emitted laser beam 30.

During measurement of the geometry of the lens as explained in the foregoing and during determination of the reflectivity of the surface of the lens the laser head 54 operates in the measuring mode. Moreover, the laser head 54 can operate in the processing mode during which it executes its scanning motion in the respective processing area in the manner described above by way of FIGS. 4, 5, 8A and 8B, and the coating is removed in this way. It is understood that the laser power is controlled in the measuring mode to have such a low value that in the measuring mode neither the apparatus is damaged nor the lenses are processed. In the processing mode the power of the laser beam is controlled to have such a high value that it is sufficient for processing a lens by local removal of the coating thereof in the processing area.

The above-described laser head 54 of the apparatus according to the second embodiment is suited both for the measuring mode and for the processing mode, i.e. the measurements and the processing are carried out by the same laser head 54. As an alternative, two laser heads may be provided one of which is suited for the measuring mode and merely carries out the measuring mode and the other is suited for the processing mode and carries out merely the latter.

The apparatuses and the method according to the second embodiment excel by the fact that by means of the apparatus and in the method the lens shape of a respective spectacle lens is automatically detected and the processing areas are allocated to the same, the lens type is automatically established and the required power density is assigned thereto and the curvature is automatically measured and correspondingly the laser power is determined so that it is superfluous, in contrast to the first embodiment, to enter respective data for each mount into the control means 68. The inputs “mount”, “processing areas”, “lens type” and “curvature” explained in connection with the first embodiment therefore need not be made in the second embodiment. This shall be illustrated in detail hereinafter.

For processing spectacle lenses by means of the apparatus according to the second embodiment, they are arranged at the mounts of the apparatus, which is in turn carried out with the aid of the lens clamps 38 inserted into the pin holes of the mounts. It applies to the following explanations that the respective lens 2 is detachably mounted with its front side 3 to the lens clamp 38. Each lens can be disposed at any of the mounts without any prescription as to which lens has to be arranged at which mounts and without any need of knowing which lens has been arranged at which mount.

After having arranged the lenses in the apparatus and at the mounts thereof, the following steps shown in the block diagram according to FIG. 16 are carried out.

Initially, in a step S1 the laser head 54 is positioned above one of the mounts and thus above the lens arranged there. The laser head 54 is then operated in the measuring mode, while the rods 70, 72 and 74 and the mounts thereof adopt their position shown in FIG. 14 so that the optical axes of the spectacle lenses extend substantially perpendicular with respect to the reference plane and the rear sides of the lenses face the laser head 54. FIG. 17 is a top view onto the lens 2 in this position, and FIG. 18 shows a view of the same lens when viewed in the direction of the arrow C in FIG. 17. During the measuring mode the laser beam 30 emitted from the laser head 54 sweeps over the area of the mounts along the lines 80 and 82. From the sensor signal SS generated in this way and the position signal PS the control means 68 detects the locations of points of the edge 5 of the lens 2 in the reference coordinate system and finally measures the entire contour 20 thereof, as this is illustrated in the block diagram according to FIG. 16 as step S2. By measuring the contour 20 the control means 68 automatically detects first if there is provided a lens at the mount above which the laser head 54 is arranged. Second, the control means 68 automatically detects by measuring the contour 20 which contour 20 the lens 2 has. Third, the control means 68 automatically detects by measuring the contour where the edge 5 of the lens 2 and the geometrical center thereof are actually provided in the reference coordinate system. This is taken into account when later positioning the laser beam in the processing area and when processing the same. In this way faults can be prevented which otherwise could occur by a faulty fastening of the lens to the lens clamp and/or by errors when entering “mount” and when entering “processing areas”.

In the memory M of the control means 68 a data table is stored in which the processing areas allocated to each lens shape in question are stored according to location, shape and size in the lens coordinate system. In a step S3, the control means 68 compares the measured contour 20 to the lens shapes stored in the data table in the memory M, in this way detects which lens shape the measured lens has and, for this lens shape, reads the allocated processing areas according to location, size and shape out of the memory M. On the basis of these data concerning the processing areas and the locations known from the contour measurement of all points on the surface and at the edge of the lens in the reference coordinate system, the control means 68 defines the position control signal PCS such that the laser head 54 is positioned in the reference coordinate system above the respective processing area by means of the positioning device 62 and that the laser beam executes the scanning motion already explained by way of the above FIGS. 4, 5, 8A and 8B in the entire processing area.

On the basis of the sensor signal SS transmitted by the sensor 76 during measuring the contour 20 or of a sensor signal SS generated during scanning the surface of the lens independently of the contour measurement, the control means 68 detects the maximum reflectivity of the lens in a step S4. In preliminary tests it has been established for each lens type which maximum reflectivity it has, and it has further been established in preliminary tests which power density is required, taking the scanning velocity v into account, to remove the respective coating in its entire thickness. The data concerning the maximum reflectivity and the assigned required power density are stored in the memory M of the control means 68. By comparison of the maximum reflectivity measured to the maximum reflectivity stored, the control means 68 detects the lens type of the lens whose maximum reflectivity has been measured, and in a step S5 the control means 68 reads the assigned power density required for said lens type out of the memory. This power density is taken as a basis of determining the beam control signal BCS by which the laser power is controlled during processing in the processing area. If, in this way, the required power density is automatically detected by the control means 68 by measuring the maximum reflectivity, the input “lens type” is superfluous and processing faults due to errors in the input “lens type” are avoided.

In a further step S6 the curvature of the surface of the lens 2 is measured on which the processing areas are located. In the FIGS. 15 to 21 this is the front side 3 of the lens 2 by which the lens is detachably fastened to the lens clamp 38. Preferably, the curvature of the lens is measured while its optical axis OA is aligned substantially in parallel to the reference plane and thus substantially perpendicular to the direction of the laser beam 30, wherein the laser beam 30 is nevertheless incident, by virtue of the curvature of the front side 3, at an incident angle of less than 90°. For this purpose, the rods 70, 72 and 74 and thus the mounts thereof are rotated out of their position shown in the FIGS. 14, 17 and 18 by approximately 90° so that the position of the lens relative to the laser beam 30 schematically shown in FIG. 19 is resulting. During measurement of the curvature in step S6, the laser head 54 is operated in the measuring mode, wherein it sweeps over the surface of the lens 2 again line by line, namely over the front side 3 thereof. The control means 68 detects the curvature of the front side 3 of the lens on the basis of the thus supplied sensor signal SS. The input “curvature” is superfluous by this automatic detection of the curvature of the lens and processing faults due to errors in the input “curvature” can be avoided.

The processing of the processing areas in the processing mode is implemented after the rods 70, 72 and 74 and thus the mounts thereof have been rotated or swiveled about further 90° from the position shown in FIG. 19 so that the optical axis of the lens is aligned substantially perpendicular to the reference plane, wherein the front side 3 of the lens now points upwards and thus faces the laser head 54. The lens is schematically illustrated in this position in FIGS. 20 and 21, FIG. 20 showing a top view on the lens 2 disposed at the rod 72 and FIG. 21 illustrating a view in the direction of the arrow E in FIG. 20. Since the rod 72 including its mounts and thus the lens 2 have been rotated out of the position shown in FIGS. 17 and 18 by a total of 180°, the lens 2 is arranged below the rod 72 so that the processing areas 26 and 28 located on the front side 3 face the laser head 54 and the laser beam 30 can be directed onto the processing areas.

The processing areas have been determined according to shape, size and location in the reference coordinate system in step S3 already. The required power density has been determined already in step S5 taking the lens type into account. The control means 68 calculates, on the basis of the curvature measured in step S6, the incident angle of the laser beam for each position of the point of incidence in the processing areas 26 and 28, as already explained in the foregoing by way of FIGS. 12 and 13. In a step S7 the control means 68 then calculates for each position of the point of incidence the power of the laser beam which is necessary with consideration of the incident angle of the laser beam calculated on the basis of the measured curvature to perform the processing in the processing area at all positions of the point of incidence with the same power density defined in step S5. In a step S8, in the processing mode the coating is then removed in the processing areas 26 and 28 by this laser power, as explained before already by way of the FIGS. 4 and 5.

It is described in the foregoing that step S4 is executed after step S2 and that step S6 is executed after step S4. In deviation therefrom, these steps can be carried out in any other order. The steps S1 to S8 are carried out for each of the mounts, however only in the event that it is determined in the respective one of the steps S2, S4 and S6 carried out first that a lens is provided at the respective mount. Furthermore, it is not necessary to execute all steps S1 to S8 at one mount before said steps are executed at one of the other mounts. Rather, each of the steps S2, S4 and S6 can initially be carried out at all mounts, whereupon one of the two others of the steps S2, S4 and S6 is carried out at all mounts and finally the remaining one of the steps S2, S4 and S6 is executed at all mounts. Accordingly, the step S8 can be carried out successively at all mounts, after the steps S2 to S7 have been carried out for all mounts before.

In the above-described second embodiment of the method the contour is measured (step 2) as well as the reflectivity is measured (step S4) and the curvature is measured (step S6). Although this is preferably done, it is not absolutely necessary in the invention. Rather, each individual one of these steps already entails advantages in processing the spectacle lenses, even if the others of these steps are not carried out.

By means of the method and the apparatus in accordance with the invention, coated spectacle lenses are processed to form at the latter joining surfaces which permit a reliable adhesive bonding of the lenses to the bridge and the lugs of rimless spectacles. It is provided in the method that for the respective spectacle lens two processing areas are predetermined with the shape, size and location thereof at the lens and that in the two predetermined processing areas the coating at the lens is locally removed by irradiation by a laser beam. The apparatus excels by a holder including at least one mount for a lens, a laser beam device including a laser head for generating a laser beam, a positioning device for moving the holder and the laser head relative to each other in a reference plane and a control means for the laser beam device and the positioning device, wherein the laser power, the relative position between the laser head and the at least one lens as well as a scanning motion of the laser beam are controllable by the control means.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A method of processing coated spectacle lenses, comprising the following steps:
a) for each coated lens, predetermining two processing areas with the shape, size and location thereof at the lens;
b) in the two predetermined processing areas, locally removing the coating on the lens by irradiation by a laser beam.

2. A method according to claim 1, wherein in step b) the laser power is controlled depending on an incident angle (a) of the laser beam onto the surface of the coated lens.

3. A method according to claim 1, wherein in step b) the laser power is controlled depending on the material of the lens and the structure of the coating.

4. A method according to claim 1, wherein the contour of the lens is measured by means of a laser beam device and in this way the lens shape thereof is detected.

5. A method according to claim 4, wherein the predetermined locations of the processing areas are assigned to each of a plurality of different presettable lens shapes, and wherein, in step b), the processing is performed in the processing areas having the locations assigned to the detected lens shape.

6. A method according to claim 1, wherein the reflectivity of the surface of the lens is measured by means of a laser beam device.

7. A method according to claim 6, wherein in preliminary tests for each coated lens, which are different as regards a base material and/or the structure of the coating, the reflectivity is detected, and the power density of the laser beam required for removing the coating is determined, so that an assignment of the reflectivity and the power density is obtained, and wherein, in step b), the power of the laser beam is controlled such that the power density assigned to the measured reflectivity is produced.

8. A method according to claim 1, wherein the curvature of the surface of the lens, processed in step b), is measured by means of a laser beam device.

9. A method according to claim 8, wherein an incident angle (α) of the laser beam on the surface of the lens in the processing area is determined on the basis of the curvature measured, and wherein, in step b), the power of the laser beam is controlled such that, taking the incident angle (α) determined into consideration, a substantial equal power density is produced in the entire processing area.

10. An apparatus for processing coated spectacle lenses, comprising:
a holder including at least one mount for a coated lens;
a laser beam device including a laser head for generating a laser beam, wherein the laser power of the laser beam is controlled such that the laser power is sufficient for processing the lens by local removal of the coating;
a positioning device for moving the holder and the laser head relative to each other in a reference plane; and
a control means for the laser beam device and the positioning device, wherein the laser power, the relative position between the laser head and the lens, and a scanning motion of the laser beam are controllable by the control means.

11. An apparatus according to claim 10, wherein the mount is pivotable such that the mount aligns the optical axis (OA) of the lens disposed at the mount differently with respect to the reference plane.

12. An apparatus according to claim 10, wherein the holder has a plurality of mounts for the lens.

13. An apparatus according to claim 12, wherein the holder includes a plurality of rods extending in parallel to each other, each of which is provided with a plurality of mounts.

14. An apparatus according to claim 10, wherein the positioning device comprises a first carriage supporting the laser head, a second carriage at which the first carriage is movable in a first direction, and rails at which the second carriage is movable in a second direction different from the first direction.

15. An apparatus according to claim 10, wherein the laser beam device comprises, in addition to the laser head suited for processing the lens, a second laser head suited for measuring the geometry of the lens.

16. An apparatus according to claim 10, wherein the laser beam device comprises a single laser head suited for measuring the geometry of the lens and for processing the lens.

17. An apparatus according to claim 15, wherein the second laser head includes a laser, capable of generating and emitting a laser beam, or the laser and a sensor capable of detecting reflected laser light and outputting a corresponding sensor signal (SS).

18. An apparatus according to claim 17, wherein the control means is formed in such a manner that the control means detects the shape of the lens on the basis of the sensor signal (SS).

19. An apparatus according to claim 18, wherein the control means includes a memory (M) for storing a plurality of different presettable lens shapes and locations of processing areas at the lens assigned to the lens shapes.

20. An apparatus according to claim 17, wherein the control means is formed in such a manner that the control means determines the reflectivity of the surface of the lens on the basis of the sensor signal (SS).

21. An apparatus according to claim 20, wherein the control means includes a memory (M) for storing the reflectivity of lenses which are different as regards a base material and/or the structure of the coating.

22. An apparatus according to claim 17, wherein the control means is formed in such a manner that, on the basis of the sensor signal (SS), the control means determines the curvature of the surface of the lens on which the laser beam, emitted by the laser, is incident.
